(19) United States
(12) Patent Application Publication
(10) Pub. No.: US 2024/0081370 A1
(43) Pub. Date: Mar. 14, 2024

(54) METHOD FOR PRODUCING FISH FRY-LIKE FOOD

(71) Applicant: FUJI OIL HOLDINGS INC., Osaka (JP)

(72) Inventors: Tomonori SATO, Ibaraki (JP); Hiroko YONEMOTO, Ibaraki (JP)

(73) Assignee: FUJI OIL HOLDINGS INC., Osaka (JP)

(21) Appl. No.: 18/271,846

(22) PCT Filed: Mar. 3, 2022
(86) PCT No.: PCT/JP2022/009102

§ 371 Date: Jul. 11, 2023

(30) Foreign Application Priority Data
Mar. 16, 2021 (JP) 2021-041933

(51) Int. Cl. A23J 3/22; A23J 3/16

(52) U.S. Cl. CPC A23J 3/227; A23J 3/16

(57) ABSTRACT

A food alternative to fish meat is provided using a textured plant protein material. The food alternative to fish meat can be prepared by binding a textured plant protein material with a binding dough, and frying this. The textured plant protein material has a crude protein content of 60 wt. % or more in a dried material. The binding dough has a gel strength after gelation (a breaking load measured using a wedge-shaped plunger with a sample having a φ3 cm cylindrical shape, a sample thickness of 1 cm, and a width of 30 mm at a speed of 1 mm/sec at room temperature) of 50 gf or higher and 800 gf or lower.

### TECHNICAL FIELD

The present invention relates to a fish fry prepared with a plant raw material.

### BACKGROUND ART

Previously, attempts have been made to produce a livestock meat-like food using a textured plant protein material. Foodstuffs prepared by binding a textured soy protein using an oil-in-water emulsion containing a powdered soy protein, egg white, and an oil and/or fat as a binding dough are considered to have a livestock meat-like texture and thus are widely used. Studies are underway to replace the strong gel of egg white with a plant material, and use of methyl cellulose (Patent Document 1) and the like has been reported.

On the other hand, there are few examples of studies on alternatives to fish meat, not those for livestock meat, and almost no studies are known on alternatives to fish fries.

### CITATION LIST

### Patent Literature

Patent Document 1: JP 2018-029565 A

### SUMMARY OF INVENTION

### Technical Problem

An object of the present invention is to provide a food alternative to fish meat using a textured plant protein material.

### Solution to Problem

As a result of diligent studies on the above problems, the present inventors have found physical properties characteristic of fish meat and its substitution and completed the present invention. That is, a textured protein material with high protein content was bound with a binding dough with a gel strength in a specific range to prepare a tissue, and the tissue was coated with batter and fried. This enabled a product of the present invention to be recognized as approximating to a fish meat-like texture in the mouth and enabled the completion of a fish fry-like food as a fish meat alternative food.

That is, the present invention relates to:
(1) A method for producing a fish fry-like food, the method comprising, in preparing an ingredient dough, binding a textured plant protein material with a binding dough, the textured plant protein material having a crude protein content of 60 wt. % or more in a dried material, and the binding dough having a gel strength after gelation of 50 gf or higher and 800 gf or lower, where the gel strength is a breaking load measured under the following conditions below: a sample having a φ of 3 cm cylindrical shape, a sample thickness of 1 cm, a plunger width of 30 mm (wedge shape), a speed of 1 mm/sec, and room temperature measurement;
(2) The method for producing a fish fry-like food according to (1), wherein the binding dough is an oil-in-water emulsion comprising a plant protein isolate and an oil and/or fat;
(3) The method for producing a fish fry-like food according to (2), wherein the textured plant protein material is in an amount of 5 to 40 wt. % in terms of dry matter in the ingredient dough, and the binding dough is in an amount of 20 to 40 wt. % in the ingredient dough;
(4) The method for producing a fish fry-like food according to (3), wherein a powdered soy protein isolate is used in an amount of 5 to 30 wt. % in the binding dough, and the oil and/or fat is used in an amount of 5 to 15 wt. % in the binding dough;
(5) The method for producing a fish fry-like food according to (1), wherein a raw material comprising an ω-3 fatty acid oil is blended;
(6) The method for producing a fish fry-like food according to (4), wherein a raw material comprising an ω-3 fatty acid oil is blended.

### Advantageous Effects of Invention

According to the present invention, the method can produce a fish fry-like food, which is a fish meat alternative food, containing a large amount of a plant material, or using only plant materials.

### DESCRIPTION OF EMBODIMENTS

### Fish Fry-Like Food

A fish fry in an embodiment of the present invention is a product produced by cutting mainly a white-meat fish, such as a cod, an Alaska pollack, a Japanese sea bass, or a hoki, into slices, then coating each slice with batter and cooking with oil. In addition, a fish fry-like food in an embodiment of the present invention is a processed product with the appearance, physical properties, and texture approximated to those of a fish fry, and is produced by processing a textured plant protein material into a fish meat-like material, then coating with batter, and cooking with oil.

### Textured Plant Protein Material

The textured plant protein material used in an embodiment of the present invention is a material that is derived from a plant and has a water-insoluble protein tissue having tissue properties. Specific examples include those produced by processing a plant raw material into a textured form, the plant raw material exemplified by soybean, defatted soybean, soy protein isolate, soy protein concentrate, wheat, wheat protein, pea, pea protein, chickpea, and mycoprotein. Examples of the textured plant protein material processed from soybean include materials in the form, such as granules, flakes, or sliced meat, produced by blending soybean, defatted soybean, soy protein isolate, and/or the like together with an additional raw material if necessary, and texturing using a single-screw or twin-screw extruder or the like. Also, for pea, mung bean, or chickpea, whole beans or peas, or a fractionated product of those is used as a raw material and subjected to a similar treatment, and this can produce a textured material.

For an embodiment of the present invention, a textured soy protein material containing soybean as a main raw material is suitable, and a product with any shape and size can be appropriately selected and used according to a desired product form. In addition, so-called gluten chips or the like prepared by processing wheat protein can also be used in an embodiment of the present invention.

Note that crude protein content (hereinafter described as “CP”) in a dried material needs to be 60 wt. % or more. If the CP is less than 60 wt. %, a fish fry-like texture could not be maintained.

### Gelling Material for Binding Dough

A binding dough used in an embodiment of the present invention is for binding the textured plant protein material described above to form an integrated fried food, and the binding dough itself has an appropriate gel strength. The binding dough can also be referred to as a dough for binding. For the binding dough, a gelling material with gelling ability of various types can be used. The gelling materials are categorized into animal gelling materials and plant gelling materials, and the plant gelling materials are categorized into plant protein gelling materials and plant non-protein gelling materials. Examples of the animal gelling material include egg white and gelatin, examples of the plant protein gelling material include legume protein, and examples of the plant non-protein gelling material include gellan gum, carrageenan, alginic acid, agar, curdlan, konjac flour, and starch.

The gelling material is preferably a plant gelling material and more preferably a plant protein gelling material. Specifically, the gelling material is preferably a plant protein, such as soy protein, pea protein, fava bean protein, or mung bean protein, more preferably a protein isolate of those, and most preferably a powdered soy protein isolate.

### Oil-in-Water Emulsion

The binding dough used in an embodiment of the present invention is preferably an oil-in-water emulsion containing an oil and/or fat. An oil and/or fat of various types can be used in the present emulsion. Specific examples include soybean oil, rapeseed oil, rice oil, corn oil, palm oil, beef tallow, pork fat, fish oil, and fractionated oils, hydrogenated oils, and transesterified oils of these, and these can be appropriately selected and used. The object of the present invention is a fish fry-like food; thus, an oil and/or fat classified as a liquid oil at normal temperature is desirably used.

In addition, partially adding an oil and/or fat containing an ω-3 polyunsaturated fatty acid, such as DHA, EPA, or α-linolenic acid, increases added value as a health material and facilitates recognition as a fish fry. The ω-3 fatty acid is contained in the oil and/or fat in an amount preferably of 0.2 to 10 wt. % and more preferably of 0.5 to 5 wt. %. Furthermore, the oil and/or fat containing the ω-3 fatty acid is not limited to the emulsion described above and can be added in any process.

### Preparation of Binding Dough

The binding dough is prepared by allowing the gelling material described above to be contained in water or an oil-in-water emulsion. The binding dough prepared using a powdered soy protein isolate and an oil and/or fat has a formulation exemplified by those in which the powdered soy protein isolate is used in an amount of 5 to 30 wt. % and preferably of 10 to 20 wt. % in the binding dough and the oil and/or fat is used in an amount of 5 to 15 wt. % and preferably of 10 to 15 wt. % in the binding dough. The binding dough is prepared by applying shear to a mixture of these raw materials and water using a mixer, a food processor, a silent cutter, a hand blender, a Stephan mixer, or the like. When an oil and/or fat is used, application of strong shear makes the emulsified particles smaller and thus is preferred.

### Gel Strength

An embodiment of the present invention is characterized by the gel strength of the binding dough. The “gel strength” here refers to a measurement of the breaking strength of the binding dough that is turned into a gel and formed into a 93 cm cylindrical shape having a thickness of 1 cm. The measurement of the breaking strength is performed by measuring the breaking load (gf) and the breaking deformation (mm) using a wedge-shaped plunger with a width of 30 mm at a speed of 1 mm/sec on a diameter portion of the sample at room temperature. The measuring instrument is exemplified by RE2-3305C available from Yamaden Co., Ltd. The binding dough of the fish fry-like food according to an embodiment of the present invention needs to have a breaking load in a range from 50 gf to 800 gf. If the breaking load is lower than 50 gf, the fish meat-like state would not be maintained, and if the breaking load is higher than 800 gf, the food would become not fish meat-like but livestock meat-like. The breaking load is preferably 100 gf or higher and 750 gf or lower.

### Preparation of Ingredient Dough

A textured plant protein material is mixed into the binding dough (before gelation) described above to prepare an ingredient dough. A seasoning, a spice, a vegetable, and the like of various types can also be added to change the flavor and physical properties. Adding a seasoning agent or flavor related to fish enables an eater to recognize more strongly that the tissue prepared in an embodiment of the present invention is fish meat-like.

For the mixing, a mixer, a food processor, a silent cutter, or the like can be used. The textured plant protein material is usually a dried material; thus, in that case, the textured plant protein material is first subjected to “rehydration”, in which the material is allowed to absorb water and thus the tissue is softened, and then the textured plant protein material is mixed. However, this does not exclude: addition and mixing of a textured plant protein material in a dry state and water; or addition and mixing of a partially rehydrated textured plant protein material and water.

In addition, a part of the water can be used as the binding dough described above. The textured plant protein material is in an amount preferably of 5 to 40 wt. % and more preferably of 8 to 30 wt. % in terms of dry matter in the ingredient dough. The binding dough is in an amount preferably of 20 to 40 wt. % and more preferably of 25 to 35 wt. % in the ingredient dough. However, when excessive water is temporarily stored in the textured plant protein material and used, resulting in dilution of the binder dough, the gel strength of the binder dough after dilution is used as a criterion for judgment.

### Molding Heating

The ingredient dough prepared in the previous process is molded into a desired size and shape with a molding machine to form an ingredient. The exemplary size range of the ingredient is 2 to 5 cm×3 to 7 cm. In addition, the thickness is important for exhibiting the texture of fish meat, and thus the thickness is preferably from 3 to 15 mm. With a thickness less than 3 mm, the texture as a fry may be deteriorated. With a thickness greater than 15 mm, the food would be more likely to be recognized as livestock meat rather than fish meat. Furthermore, the coating thickness may also affect, and the thickness ratio of the ingredient to the coating is preferably from 3:7 to 7:3.

The fish fry-like food can be produced by applying a batter liquid to the ingredient molded into a predetermined size, covering the battered ingredient with breadcrumbs, and cooking the coated ingredient with oil at from 170 to 190° C. Undergoing the frying process results in a fish fry-like food with more enhanced fish meat texture compared with undergoing a simple heat treatment of the dough.

The present invention will be explained by describing examples below.

### Example 1

### Gel Strength of Binding Dough

Water, an oil and/or fat, a powdered soy protein isolate (NEW FUJIPRO 2000N available from Fuji Oil Co., Ltd.), and a dried egg white powder (Egg White K, Kewpie Egg Co., Ltd.) were mixed according to the formulations shown in Table 1. The mixtures were each stirred in a robot coupe, and curd-like oil-in-water emulsions were prepared as binders (doughs) A to G. The oil and/or fat contained 5 parts by weight of polyunsaturated fatty acid-containing oil and/or fat (oil and/or fat containing 40 wt. % of DHA and EPA in total) and 95 parts by weight of rapeseed oil.

The binders (doughs) A to G were each filled in a casing with a folded diameter of 48 mm and turned into a gel by heating at 90° C. for 50 minutes using a steam mode of a convection oven. These were each cut to a 1-cm thickness, and then the breaking strength of each gel was measured with a wedge-shaped plunger with a width of 30 mm (1 mm/sec) using a creep meter (RE2-3305C available from Yamaden Co., Ltd.). In Table 1, the maximum load (gf) of each gel is listed.

Binders containing a larger amount of egg white turned to stronger gels, and binders containing a larger amount of water turned to weaker gels.

TABLE 1
Gel Strength of Binding Dough

| | Formulation (parts by weight) | | | | Physical |
|---|---|---|---|---|---|
| | Powdered | | | Dried egg | properties |
| | soy protein | | Oil and/ | white | Maximum load |
| Name | isolate | Water | or fat | powder | (gf) |
| Binder A | 5.0 | 20.0 | 4.0 | — | 570.8 |
| Binder B | ↑ | ↑ | ↑ | 0.5 | 643.4 |
| Binder C | ↑ | ↑ | ↑ | 1.0 | 728.1 |
| Binder D | ↑ | ↑ | ↑ | 2.0 | 865.2 |
| Binder E | ↑ | ↑ | ↑ | 3.0 | 1073.8 |
| Binder F | 4.3 | 21.5 | 3.4 | — | 247.5 |
| Binder G | 3.7 | 22.2 | 3.0 | — | 82.3 |

### Example 2

Trial Production with Each Binding Dough

To each of binding doughs A to G, a textured soy protein material (Response 4400 available from DuPont de Nemours, Inc.) rehydrated with water, a seasoning, and a spice were added according to the formulations in Table 2. Each mixture was stirred in a mixer, and ingredient doughs were prepared. Each ingredient dough was molded into 96 mm×55 mm×12 mm, steamed at 90° C. for 12 minutes with a steam mode of a convection oven (CPC 101 available from RATIONAL AG), cooled, and then cut into 55 mm×32 mm×6 mm. Each of these were covered with a batter liquid and breadcrumbs, then treated with rapeseed oil at 175° C. for 4 minutes, and a fish fry-like food was produced. The coating thickness was 6 mm.

TABLE 2
Trial Production with Each Binding Dough

| Trial | Formulation (parts by weight) | | | | | | | | | | Fry evaluation | |
|---|---|---|---|---|---|---|---|---|---|---|---|---|
| production | Binder | | | | | | | Textured | | Seasoning | Binder hardness | Overall |
| example | A | B | C | D | E | F | G | soy protein | Water | Spice | evaluation | acceptability |
| T1 | 29.0 | | | | | | | 20.0 | 40.0 | 7.5 | ⊚ | Acceptable |
| T2 | | 29.5 | | | | | | ↑ | ↑ | ↑ | ◯ | Acceptable |
| T3 | | | 30.0 | | | | | ↑ | ↑ | ↑ | Δ to ◯ | Acceptable |
| T4 | | | | 31.0 | | | | ↑ | ↑ | ↑ | X | Unacceptable |
| T5 | | | | | 32.0 | | | ↑ | ↑ | ↑ | XX | Unacceptable |
| T6 | | | | | | 29.2 | | ↑ | ↑ | ↑ | ◯ | Acceptable |
| T7 | | | | | | | 28.9 | ↑ | ↑ | ↑ | Δ | Acceptable |

### Sensory Evaluation Criteria

The sensory evaluation was performed by five skilled panelists, and the fish fry-like texture was evaluated from both aspects of the binding dough and the textured protein, and the final acceptability was judged by discussion.

The descriptions of × (poor) to ⊚ (excellent) in the table is based on the following. ⊚: comparable to an ordinary fish fry and particularly good
◯: no problem as a fish fry-like food and good
Δ: slightly inferior but within the range of a fish fry-like food
×: unnatural as a fish fry-like food and inappropriate
××: further unnatural and inappropriate

### Final Evaluation

Acceptable: Usable without any Inferiority to an Ordinary Fish Fry
Unacceptable: still unnatural as a fish fry-like food.

### Evaluation

The sensory evaluation results due to the difference in the binding dough are listed in Table 2. In T1 using binder A, a good fish fry-like food was prepared. However, as the amount of egg white used increased with that in binder E at the top, the fish fry-like texture decreased, and the livestock meat-like texture became stronger. In addition, binders F and G, in which the amount of the soy protein isolate was reduced and the amount of water was increased relative to binder A, were not judged inappropriate but resulted in an excessively soft texture as a whole, and a decrease in the fish fry-like texture was observed.

These correlated with the gel strength in Table 1; binders with a maximum load of 800 gf or higher produced fish fry-like foods judged inappropriate as observed in some results.

### Example 3

Trial Production with Each Textured Soy Protein Material

Binder A was mixed with each of various textured soy protein materials according to the formulations shown in Table 3, and fish fry-like foods were produced by preparing in the same manner as in Example 2. Moreover, GS52 is a textured soy protein available from Gushen Biotechnology Group Co., Ltd., and APEX 650, APEX 2000SP, and NEW FUJINIK 52S are all textured soy proteins available from Fuji Oil Co., Ltd., which differ in crude protein content (CP).

TABLE 3
Trial Production with Each Textured Material

| | | | Formulation (parts by weight) | | | | Fry evaluation | |
|---|---|---|---|---|---|---|---|---|
| Trial | Textured | | Textured | | | | Texture evaluation | |
| production | soy protein | | soy | | Binder | Seasoning | of textured protein | Overall |
| example | material | (CP %) | protein | Water | A | Spice | material | acceptability |
| T1 | Response 4400 | (68.0) | 20.0 | 40.0 | 29.0 | 4.0 | ⊚ | Acceptable |
| T8 | GS52 | (68.0) | 20.0 | 40.0 | ↑ | ↑ | ⊚ to ◯ | Acceptable |
| T9 | APEX 650 | (69.6) | 12.0 | 48.0 | ↑ | ↑ | ◯ | Acceptable |
| T10 | APEX 2000SP | (74.1) | 15.0 | 45.0 | ↑ | ↑ | ◯ | Acceptable |
| T11 | NEW FUJINIK 52S | (55.0) | 20.0 | 40.0 | ↑ | ↑ | X | Unacceptable |

### Evaluation

The sensory evaluation results due to the CP difference in the textured soy protein are listed in Table 3. The textured soy protein material with a CP below 60 failed to maintain the layered structure and to produce the fish meat-like texture, and was judged inappropriate.

### Example 4

Comparative Study with Non-Fried Product

A fish fry-like food was prepared using binder A according to T1 of Example 2. However, the ingredient dough as it was without coating with batter after molding was heated in a convection oven at 210° C. for 3 minutes.

TABLE 4
Comparison with Non-fried Product

| Trial production | Heating | Fish-like texture |
|---|---|---|
| example | method | evaluation |
| T1 | Frying | Fish-like texture was |
| | | felt and good |
| T12 | Heated in oven and not | Livestock meat-like |
| | coated with batter | texture remained |

### Evaluation

The sensory evaluation results of the fish-like texture in comparison with the non-fried product are listed in Table 4. The product not coated with batter and not fried but merely heated had remaining livestock meat-like texture and was difficult to recognize as fish meat.

### Example 5

Gel Strength with Another Protein

Gels were prepared according to the formulations in Table 5 in the same manner as in Example 1, and the maximum loads were measured. The pea protein used was PP-CS available from Organo Foodtech Corporation, the fava bean protein used was FP-AC available from Organo Foodtech Corporation, and the mung bean protein used was MP-AC available from Organo Foodtech Corporation. All resulted in a slightly soft gel compared with the soybean (binder A).

TABLE 5
Gel Strength with Another Protein

| | Formulation (parts by weight) | | | | | Physical |
|---|---|---|---|---|---|---|
| | | Fava | Mung | | Oil | properties |
| | Pea | bean | bean | | and/or | Maximum |
| Name | protein | protein | protein | Water | fat | load (gf) |
| Binder H | 7.3 | | | 18.1 | 3.7 | 212.3 |
| Binder I | | 6.4 | | 19.4 | 3.2 | 182.9 |
| Binder J | | | 6.4 | 19.4 | 3.2 | 460.3 |

### Example 6

Trial Production of Fish Fry-Like Food with Another Protein

Fish fry-like foods were prepared according to the formulations in Table 6 in the same manner as in Example 2, and the sensory evaluation was performed. All produced a fish fry comparable to an ordinary fish fry.

TABLE 6
Trial Production with Another Protein

| | | | | | | | Fry evaluation | |
|---|---|---|---|---|---|---|---|---|
| Trial | Formulation (parts by weight) | | | | | | Binder | |
| production | Binder | | | Textured | | Seasoning | hardness | Overall |
| example | H | I | J | soy protein | Water | Spice | evaluation | acceptability |
| T13 | 29.1 | | | 20.0 | 40.0 | 7.5 | ◯ | Acceptable |
| T14 | | 29.0 | | ↑ | ↑ | ↑ | ◯ | Acceptable |
| T15 | | | 29.0 | ↑ | ↑ | ↑ | ⊚ | Acceptable |

### INDUSTRIAL APPLICABILITY

According to the present invention, a fish fry-like food as a food alternative to fish meat can be easily provided by using a textured plant protein material, with the use of an animal material being eliminated or reduced.

What is claimed is:

1. A method for producing a fish fry-like food, the method comprising, in preparing an ingredient dough, binding a textured plant protein material with a binding dough, the textured plant protein material having a crude protein content of 60 wt. % or more in a dried material, and the binding dough having a gel strength after gelation of 50 gf or higher and 800 gf or lower,
where the gel strength is a breaking load measured under the following conditions: a sample having a φ3 cm cylindrical shape, a sample thickness of 1 cm, a plunger width of 30 mm (wedge shape), a speed of 1 mm/sec, and room temperature measurement.

2. The method for producing a fish fry-like food according to claim 1, wherein the binding dough is an oil-in-water emulsion comprising a plant protein isolate and an oil and/or fat.

3. The method for producing a fish fry-like food according to claim 2, wherein the textured plant protein material is in an amount of 5 to 40 wt. % in terms of dry matter in the ingredient dough, and the binding dough is in an amount of 20 to 40 wt. % in the ingredient dough.

4. The method for producing a fish fry-like food according to claim 3, wherein a powdered soy protein isolate is used in an amount of 5 to 30 wt. % in the binding dough, and the oil and/or fat is used in an amount of 5 to 15 wt. % in the binding dough.

5. The method for producing a fish fry-like food according to claim 1, wherein a raw material comprising an ω-3 fatty acid oil is blended.

6. The method for producing a fish fry-like food according to claim 4, wherein a raw material comprising an ω-3 fatty acid oil is blended.
